(19) United States
(12) Patent Application Publication
(10) Pub. No.: US 2025/0216728 A1
(43) Pub. Date: Jul. 3, 2025

(54) INTELLIGENT REFLECTING SURFACE HAVING INTEGRATED DISPLAY PART

(71) Applicant: Japan Display Inc., Tokyo (JP)

(72) Inventors: Daiichi SUZUKI, Tokyo (JP); Shinichiro OKA, Tokyo (JP); Mitsutaka OKITA, Tokyo (JP)

(73) Assignee: Japan Display Inc., Tokyo (JP)

(21) Appl. No.: 19/081,002

(22) Filed: Mar. 17, 2025

Related U.S. Application Data
(63) Continuation of application No. PCT/JP2023/028266, filed on Aug. 2, 2023.

(30) Foreign Application Priority Data
Sep. 22, 2022 (JP) 2022-151875

(51) Int. Cl. G02F 1/1347; G02F 1/1343

(52) U.S. Cl. CPC G02F 1/13478; G02F 1/134309; G02F 2203/02

(57) ABSTRACT

An intelligent reflecting surface includes a plurality of first patch electrodes, a plurality of second patch electrodes facing the plurality of first patch electrodes and spaced apart, an electrode layer facing the plurality of second patch electrodes and spaced apart on the opposite side of the plurality of second patch electrodes from the side on which the plurality of first patch electrodes is provided, a first liquid crystal layer provided between the plurality of first patch electrodes and the plurality of second patch electrodes, a first substrate provided between the plurality of second patch electrodes and the electrode layer, an array substrate including a plurality of transistors and provided on the opposite side of the electrode layer from the side on which the first substrate is provided, and a second liquid crystal layer provided between the array layer and the electrode layer.

### CROSS-REFERENCE TO RELATED APPLICATIONS

This application is a Continuation of International Patent Application No. PCT/JP2023/028266, filed on Aug. 2, 2023, which claims the benefit of priority to Japanese Patent Application No. 2022-151875, filed on Sep. 22, 2022, the entire contents of which are incorporated herein by reference.

### FIELD

An embodiment of the present invention relates to an intelligent reflecting surface having an integrated display part (a display panel integrated with a radio wave reflecting device) that can display an image and control a traveling direction of reflected radio waves.

### BACKGROUND

In the communication field, the introduction of the fifth-generation communication standard called 5G is progressing. In this communication standard, a millimeter-wave-band frequency (26 GHz or more, e.g., 26 GHz to 29 GHz) is adopted. Communication according to the 5G standard can achieve very high-throughput by adopting a millimeter-wave-band frequency, and can be transmitted over a wide bandwidth.

In the communication according to the 5G standard, an attempt has been made to use, for example, a phased array antenna device, a meta surface reflector, or the like, in order to change the transmission direction of radio waves and widen the communication area while avoiding obstacles.

The phased array antenna device includes a plurality of antenna elements arranged in a planar shape, and by adjusting the amplitude and phase of a high-frequency signal applied to each of the plurality of antenna elements, it is possible to control the directivity of the antenna in a state in which each of the plurality of antenna elements is fixed. For example, there is known a phased array antenna device that adjusts an amplitude and phase of a high-frequency signal to be applied to each of the plurality of antenna elements and utilizes a change in dielectric constant due to the alignment state of a liquid crystal.

The meta surface reflector includes a plurality of structures (meta surface) sufficiently smaller than the wavelength of the electromagnetic wave, and the directivity of the antennae can be controlled by adjusting the amplitude and phase of the high-frequency signal applied to the meta surface. In addition, for example, a meta surface reflector that utilizes a change in the alignment state of a liquid crystal is known.

Furthermore, in recent years, signage or digital signage represented by electronic signboards has been popularized in all places, such as public spaces such as streets, stations, commercial facilities, small stores, and shops in hotels, without distinction between outdoors and indoors. In particular, a reflective display device does not require a backlight light source and has high visibility with external light such as sunlight as a light source, and has low power consumption. Therefore, a reflective display device is starting to be used as an outdoor electronic signboard.

### SUMMARY

An intelligent reflecting surface includes a plurality of first patch electrodes, a plurality of second patch electrodes facing and spaced apart from the plurality of first patch electrodes, an electrode layer facing and spaced apart from the plurality of second patch electrodes on the side opposite the side on which the plurality of first patch electrodes is provided with respect to the plurality of second patch electrodes, a first liquid crystal layer provided between the plurality of first patch electrodes and the plurality of second patch electrodes, a first substrate provided between the plurality of second patch electrodes and the electrode layer, an array substrate provided on the side opposite the side on which the first substrate is provided with respect to the electrode layer, the array substrate including a plurality of transistors, and a second liquid crystal layer provided between the array substrate and the electrode layer.

### BRIEF DESCRIPTION OF DRAWINGS

FIG. 1 is a cross-sectional view showing a configuration of a display panel integrated radio wave reflecting device according to the first embodiment of the present invention.

FIG. 2 is a plan view showing a reflector unit cell used in a display panel integrated radio wave reflecting device according to the first embodiment of the present invention.

FIG. 3 is a cross-sectional view showing a cut surface of a line A1-A2 shown in FIG. 1.

FIG. 4 is a diagram showing a state in which no voltage is applied between a patch electrode and a ground electrode in a reflector unit cell used in a display panel integrated radio wave reflecting device according to the first embodiment of the present invention.

FIG. 5 is a diagram showing a state in which a voltage is applied between a patch electrode and a ground electrode in a reflector unit cell used in a display panel integrated radio wave reflecting device according to the first embodiment of the present invention.

FIG. 6 is a diagram schematically showing that the traveling direction of a reflected wave is changed by a display panel integrated radio wave reflecting device according to the first embodiment of the present invention.

FIG. 7 is a plan view showing a configuration of a radio wave reflecting part according to the first embodiment of the present invention.

FIG. 8 is a plan view showing a configuration of the reflector unit cell shown in FIG. 7.

FIG. 9 is a cross-sectional view showing a cut surface of the reflector unit cell shown in FIG. 8.

FIG. 10 is a plan view showing a configuration of a display panel part according to the first embodiment of the present invention.

FIG. 11 is a plan view showing a configuration of a display panel part according to the first embodiment of the present invention.

FIG. 12 is a circuit diagram showing a circuit configuration of a pixel according to the first embodiment of the present invention.

FIG. 13 is a cross-sectional view showing a cross-sectional structure of a pixel 300 along a line B1-B2 shown in FIG. 10.

FIG. 14 is a cross-sectional view showing a cross-sectional structure of the pixel shown in FIG. 10.

FIG. 15 is a perspective view showing a usage example of a display panel integrated radio wave reflecting device according to the first embodiment of the present invention.

FIG. 16 is a diagram showing a configuration of a display panel integrated radio wave reflecting device according to the second embodiment of the present invention.

FIG. 17 is a plan view showing a reflector unit cell used in a display panel integrated radio wave reflecting device according to the second embodiment of the present invention.

FIG. 18 is a cross-sectional view showing a cut surface of a line C1-C2 shown in FIG. 17.

### DESCRIPTION OF EMBODIMENTS

A radio wave reflecting device including a phased array antenna device, a meta surface reflector, and the like, and an electronic signboard including a reflective display device are arranged in a place where there are many users of radio waves and electronic signboards, such as a square in front of a station, a public space, a waiting place, and the like. Since the area in which a radio wave reflecting device and an electronic signboard can be arranged such as a square in front of a station, a public space, and a waiting place, and the like is limited, the area in which the radio wave reflecting device and the electronic signboard are arranged may compete, and the number of radio wave reflecting devices and electronic signboards to be arranged may be limited.

For example, communication avoiding an obstacle becomes difficult in the case where the number of radio wave reflecting devices to be arranged is limited. As a result, there is a possibility that a dead zone of radio waves (a place where radio waves do not reach) cannot be solved, in the case where the number of radio wave reflecting devices to be arranged is limited. In addition, for example, in the case where the number of electronic signboards to be arranged is limited, the user may not be able to acquire desired information.

In view of the above, an object of an embodiment of the present invention is to provide a display panel integrated radio wave reflecting device in which a display panel and a radio wave reflecting device are integrated.

Hereinafter, a display panel integrated radio wave reflecting device of the present invention will be described while referring to the drawings and the like. However, the present invention can be implemented in many different aspects, and should not be construed as being limited to the description of the embodiments exemplified below. In order to make the description clearer, the drawings may be schematically represented with respect to the width, thickness, shape, and the like of each part as compared with the actual embodiment, but the drawings are merely examples, and do not limit the interpretation of the present invention. In addition, in the present specification and the drawings, elements similar to those described above with respect to the above-described figures are denoted by the same reference signs (or reference signs denoted by a, b, and the like after numerals) and detailed description thereof may be omitted as appropriate. Furthermore, the terms “first” and “second” with respect to the respective elements are convenient signs used to distinguish the respective elements, and do not have any further meaning unless otherwise specified.

In the present specification, a member or region is “on (or under)” another member or region, including, without limitation, the case where it is directly on (or under) the other member or region, but also when it is above (or below) the other member or region, that is, the case where another component is included above (or below) the other member or region.

In the present specification, a direction D1 intersects a direction D2, and a direction D3 intersects the direction D1 and the direction D2 (D1D2 plane). The direction D1 is referred to as a first direction, the direction D2 is referred to as a second direction, and the direction D3 is referred to as a third direction.

In the present specification, when the terms “the same” and “match” are used, the same and match may include errors within the scope of the design.

### First Embodiment

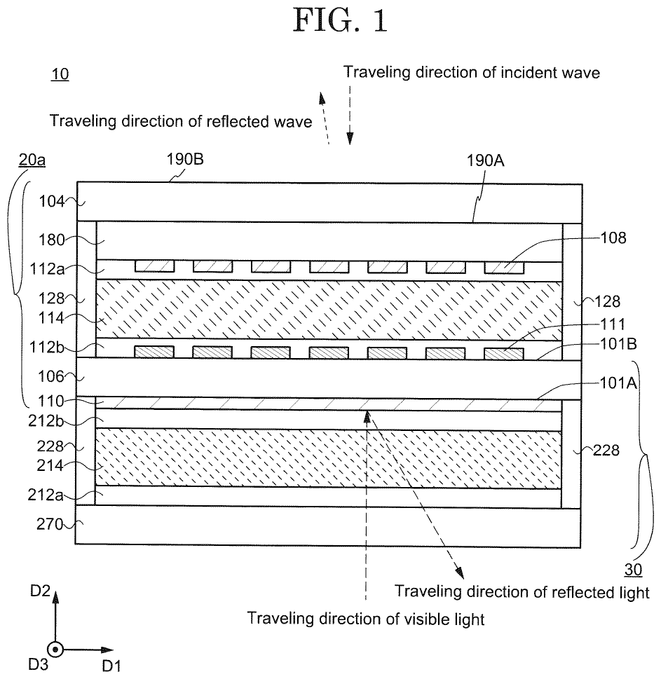

In the first embodiment, a display panel integrated radio wave reflecting device 10 including a radio wave reflecting part 20a capable of biaxial reflection control will be described with reference to FIG. 1 to FIG. 15.

### [1. Overview of Radio Wave Reflecting Device Including Display Panel 10]

An outline of the display panel integrated radio wave reflecting device 10 will be described with reference to FIG. 1. FIG. 1 is a cross-sectional view showing a configuration of the display panel integrated radio wave reflecting device 10. As shown in FIG. 1, the display panel integrated radio wave reflecting device 10 includes the radio wave reflecting part 20a and a display panel part 30.

The radio wave reflecting part 20a has a function of reflecting radio waves. The radio wave reflecting part 20a includes a dielectric substrate 104, an array layer 180, a plurality of first patch electrodes 108, a first alignment film 112a, a liquid crystal layer 114, a sealing material 128, a second alignment film 112b, a plurality of second patch electrodes 111, a counter substrate 106, and an electrode layer 110.

The display panel part 30 has a function of displaying images. The display panel part 30 includes an array substrate 270, a third alignment film 212a, a liquid crystal layer 214, a sealing material 228, a fourth alignment film 212b, the electrode layer 110, and the counter substrate 106.

The radio wave reflecting part 20a and the display panel part 30 share the counter substrate 106 and the electrode layer 110. For example, as shown in FIG. 1, the radio wave reflecting part 20a reflects radio waves corresponding to the 5G standard communication in the traveling direction of the reflected wave with respect to the traveling direction of the incident wave by using the electrode layer 110. In addition, for example, as shown in FIG. 1, the display panel part 30 reflects visible light in the traveling direction of the reflected light with respect to the traveling direction of the visible light by using the electrode layer 110.

That is, in the display panel integrated radio wave reflecting device 10, the radio wave reflecting part 20a and the display panel part 30 share the counter substrate 106 and the electrode layer 110. In addition, the electrode layer 110 has two functions: a function of reflecting radio waves corresponding to the 5G standard communication, and a function of reflecting visible light. In the case where the display panel part having a function of displaying images and the radio wave reflecting part having a function of reflecting radio waves are individually manufactured and a device including the display panel part and the radio wave reflecting part is assembled, at least an electrode layer and a substrate including the electrode layer is required for both the display panel part and the radio wave reflecting part, and the manufacturing cost of the device including the display panel part and the radio wave reflecting part is high. On the other hand, in the display panel integrated radio wave reflecting device 10, the radio wave reflecting part 20a and the display panel part 30 can be integrally formed while sharing the counter substrate 106 and the electrode layer 110 of the radio wave reflecting part 20a and the display panel part 30. As a result, the manufacturing cost of the display panel integrated radio wave reflecting device 10 can be reduced compared with the device in which the display panel part and the radio wave reflecting part are manufactured separately and assembled.

[2. Radio Wave Reflecting Part 20a]

### [2-1. Overview]

An overview of the radio wave reflecting part 20a used in the display panel integrated radio wave reflecting device 10 according to the first embodiment and a reflector unit cell 102 included in the radio wave reflecting part 20a will be described with reference to FIG. 1 to FIG. 6. The description of the same or similar configurations as those in FIG. 1 will be omitted.

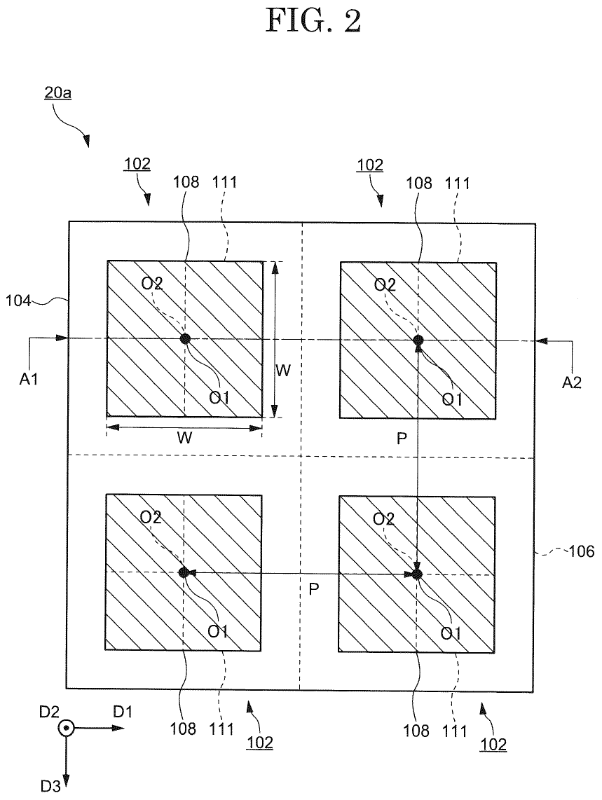

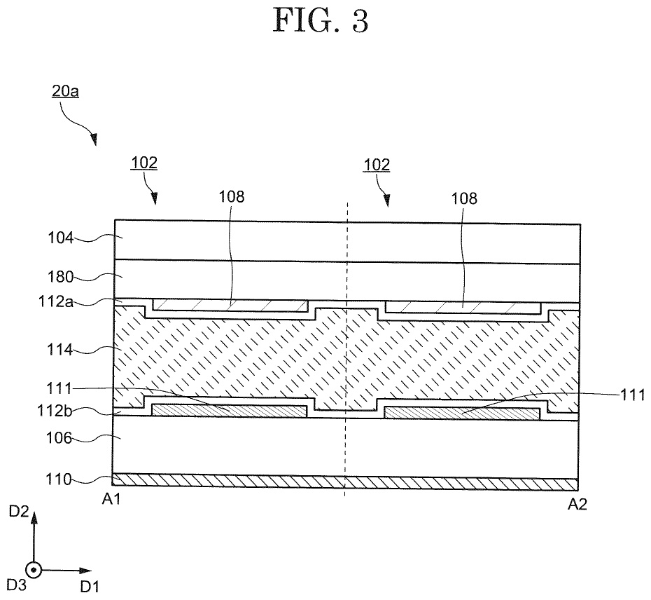

FIG. 2 is a plan view when the four reflector unit cells 102 are viewed from above (from the side where radio waves are incident). FIG. 3 is a cross-sectional view showing a cut surface of a line A1-A2 shown in FIG. 2.

As described with reference to FIG. 1 in “1. Overview of Display Panel Integrated Radio Wave Reflecting Device 10”, the radio wave reflecting part 20a includes the dielectric substrate 104, the array layer 180, the plurality of first patch electrodes 108, the first alignment film 112a, the liquid crystal layer 114, the sealing material 128, the second alignment film 112b, the plurality of second patch electrodes 111, the counter substrate 106, and the electrode layer 110.

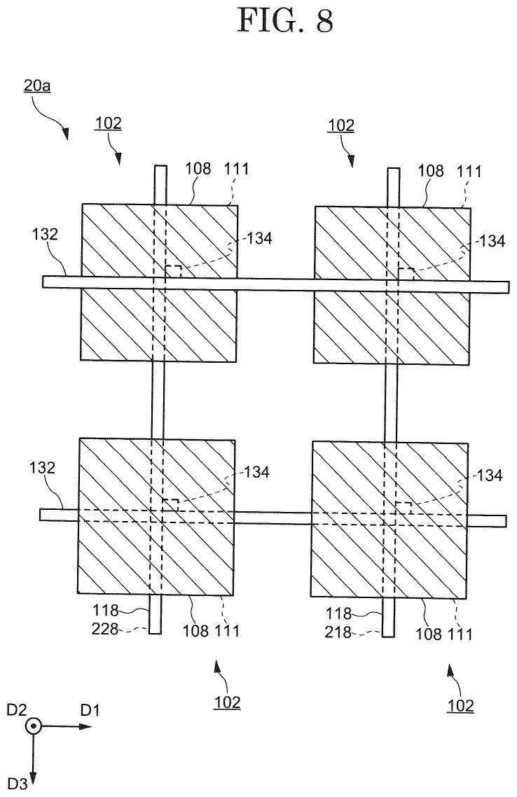

In addition, as shown in FIG. 1, FIG. 2, or FIG. 3, the radio wave reflecting part 20a includes a plurality of reflector unit cells 102. One reflector unit cell 102 includes the dielectric substrate 104, the array layer 180, the first patch electrode 108, the first alignment film 112a, the liquid crystal layer 114, the sealing material 128, the second alignment film 112b, the second patch electrode 111, the counter substrate 106, and the electrode layer 110. The dielectric substrate 104 is shared in the plurality of reflector unit cells 102. Therefore, the dielectric substrate 104 may be regarded as a dielectric layer forming one layer. Therefore, the dielectric substrate 104 may be referred to as a dielectric layer. Although details will be discussed later, the array layer 180 includes a switching element 134 (see FIG. 8) that is electrically connected to the first patch electrode 108.

As shown in FIG. 2, in a plan view of the plurality of reflector unit cells 102, the plurality of first patch electrodes 108 is arranged in a matrix in the direction D1 (first direction) and the direction D3 (third direction) intersecting the direction D1. The distance between a center O1 of the first patch electrode 108 and a center O1 of the adjacent first patch electrode 108, which is parallel to the direction D1, is a distance P. In addition, similar to the direction D1, the distance between the center O1 of the first patch electrode 108 and the center O1 of the adjacent first patch electrode 108, which is parallel to the direction D3, is the distance P. That is, the plurality of first patch electrodes 108 is arranged at the same pitch (distance P) in the direction D1 and the direction D3. The shape of the first patch electrode 108 is a square. The length of one side parallel to the direction D1 is the same as the length of one side parallel to the direction D2, and the length is a length W.

As shown in FIG. 1 to FIG. 3, the second patch electrode 111 overlaps the first patch electrode 108. The plurality of second patch electrodes 111 has a similar configuration as the plurality of first patch electrodes 108. Therefore, the plurality of second patch electrodes 111 is arranged in a matrix in the direction D1 and the direction D3. The distance between the center O2 of the second patch electrode 111 and the center O2 of the adjacent second patch electrode 111, which is parallel to the direction D1, is the distance P. In addition, the distance between the center O2 of the second patch electrode 111 and the center O2 of the adjacent second patch electrode 111, which is parallel to the direction D3, is the distance P. That is, the plurality of second patch electrodes 111 is arranged at the same pitch (distance P) in the direction D1 and the direction D3. In addition, the shape of the second patch electrode 111 is a square. The length of one side parallel to the direction D1 is the same as the length of one side parallel to the direction D2, and the length is the length W.

For example, the distance W can be selected from a range of 2.5 mm or more and 3.0 mm or less, and the distance P can be selected from a range of 3.5 mm or more and 4.0 mm or less.

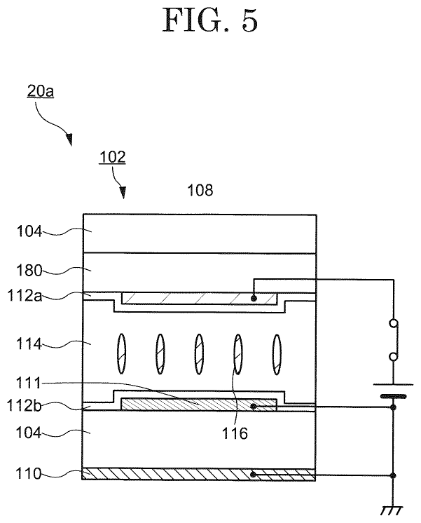

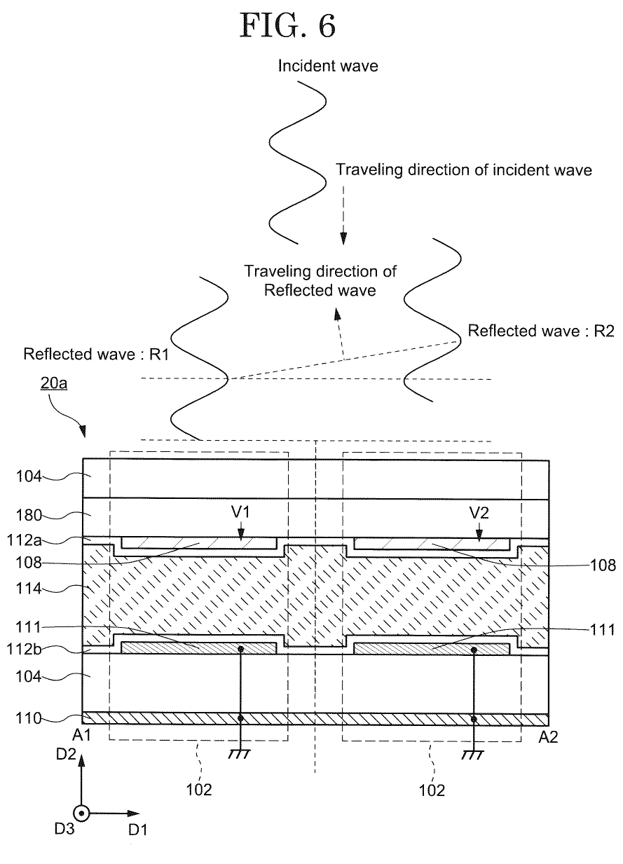

The square is shaped to have four rotational symmetry for each of the center O1 of the first patch electrode 108 and the center O2 of the second patch electrode 111. In the reflector unit cell 102, the first patch electrode 108 and the second patch electrode 111 have the same configuration, the first patch electrode 108 overlaps the second patch electrode 111, the first patch electrode 108 has a rotational symmetry with respect to the center O1, and the second patch electrode 111 has a rotational symmetry with respect to the center O2, so that the anisotropy with respect to the reflectance of the radio wave can be reduced with respect to the vertically polarized wave and the horizontally polarized wave of the incident radio wave. That is, the polarization of the vertically polarized wave and the horizontally polarized wave in the XY plane in FIG. 1, FIG. 5, and FIG. 6 can be suppressed, and the vertically polarized wave and the horizontally polarized wave can be uniformly reflected.

The shapes of the first patch electrode 108 and the second patch electrode 111 are not limited to a square. The shapes of the first patch electrode 108 and the second patch electrode 111 may be a rhombus, a square with each vertex chamfered, or a square with each vertex rounded. The shapes of the first patch electrode 108 and the second patch electrode 111 may be any shapes that have four rotational symmetry with respect to each of the center O1 of the first patch electrode 108 and the center O2 of the second patch electrode 111.

The shape of the electrode layer 110 is not limited. For example, the shape of the electrode layer 110 may be any shape having an area larger than that of the first patch electrode 108 and the second patch electrode 111. In the display panel integrated radio wave reflecting device 10, the electrode layer 110 is arranged on the entire surface or substantially the entire surface of a first main surface 101A of the counter substrate 106. Furthermore, in the display panel integrated radio wave reflecting device 10, the electrode layer 110 is grounded and may be referred to as a ground electrode.

In addition, the material for forming the first patch electrode 108, the second patch electrode 111, and the electrode layer 110 is not limited. For example, the first patch electrode 108, the second patch electrode 111, and the electrode layer 110 are formed using a conductive metal or a metal oxide.

In addition, although details will be described later, a first wiring 118 may be provided in the dielectric substrate 104. For example, the first wiring 118 connects the plurality of first patch electrodes 108 arranged in the same row. In addition, a first wiring 218 may be provided in the counter substrate 106. The first wiring 218 connects the plurality of second patch electrodes 111 arranged in the same row. The first wiring 118 and the first wiring 218 may be used to apply a control signal to the first patch electrode 108 and the second patch electrode 111.

The reflector unit cell 102 is used as a reflector 120 that reflects radio waves in a predetermined direction. Therefore, it is preferable that the amplitude of the reflected radio wave of the reflector unit cell 102 is not attenuated as much as possible. As is evident from the structures shown in FIG. 1 and FIG. 3, when a radio wave propagating through the air is reflected by the reflector unit cell 102, the radio wave passes through the dielectric substrate 104 twice. For example, the dielectric substrate 104 is preferably formed of a dielectric material such as glass or resin.

The array layer 180 is provided on the dielectric substrate 104. The plurality of first patch electrodes 108 is provided on the array layer 180. The first alignment film 112a is provided to cover the plurality of first patch electrodes 108. The electrode layer 110 is provided on the first main surface 101A of the counter substrate 106. The plurality of second patch electrodes 111 is provided on a second main surface 101B of the counter substrate 106. The second alignment film 112b is provided so as to cover the plurality of second patch electrodes 111. The first patch electrode 108 is provided to face the second patch electrode 111 and the electrode layer 110. The second patch electrode 111 is provided to face the first patch electrode 108 and the electrode layer 110. The liquid crystal layer 114 is provided between the first patch electrode 108 and the second patch electrode 111. The first alignment film 112a is interposed between the first patch electrode 108 and the liquid crystal layer 114. The second alignment film 112b is interposed between the second patch electrode 111 and the liquid crystal layer 114.

The dielectric substrate 104 is bonded to the counter substrate 106 using the sealing material 128. The dielectric substrate 104 is arranged opposite the counter substrate 106 so that a gap is included between the dielectric substrate 104 and the counter substrate 106. The array layer 180 and the liquid crystal layer 114 are provided in a region surrounded by the sealing material 128. The first patch electrode 108, the first alignment film 112a, the second alignment film 112b, and the second patch electrode 111 are provided between the dielectric substrate 104 and the counter substrate 106. Specifically, the gap between the first alignment film 112a and the second alignment film 112b provided in each of the dielectric substrate 104 and the counter substrate 106 is the thickness of the liquid crystal layer 114. For example, the thickness of the liquid crystal layer 114 is 50 μm. In addition, although not shown, a spacer to maintain a constant interval may be provided between the dielectric substrate 104 and the counter substrate 106.

A control signal for controlling the orientation of liquid crystal molecules of the liquid crystal layer 114 is applied to the first patch electrode 108. The control signal is a DC voltage signal or a polarity inversion signal in which a positive DC voltage and a negative DC voltage are alternately inverted. A ground voltage or a voltage of an intermediate level of a polarity inversion signal is applied to the second patch electrode 111 and the electrode layer 110. When the control signal is applied to the first patch electrode 108, the alignment state of the liquid crystal molecules included in the liquid crystal layer 114 changes. A liquid crystal material having dielectric anisotropy is used for the liquid crystal layer 114. For example, a nematic liquid crystal, a smectic liquid crystal, a cholesteric liquid crystal, or a discotic liquid crystal is used as the liquid crystal layer 114. In the liquid crystal layer 114 having dielectric anisotropy, the dielectric constant changes due to a change in the alignment state of the liquid crystal molecules. The reflector unit cell 102 may change the dielectric constant of the liquid crystal layer 114 by changing the orientation state of the liquid crystal molecules included in the liquid crystal layer 114 according to the control signal applied to the first patch electrode 108. As a result, when the radio wave reflecting part 20a reflects the radio wave, the phase of the reflected wave can be delayed. For example, the ground voltage may be a ground voltage (GND voltage) or a voltage of 0 V.

The frequency bands of the radio waves reflected by the reflector unit cell 102 are the ultra-high frequency (VHF: Very High Frequency) band, the ultra-high frequency (UHF: Ultra-High Frequency) band, the microwave (SHF: Super High Frequency) band, the sub-millimeter wave (THF: Tremendously high frequency) band, and the millimeter wave (EHF: Extra High Frequency) band. In addition, the millimeter wave refers to a frequency band between 30 GHZ and 300 GHz. Furthermore, the frequency band of the fifth-generation communication standard called 5G includes a 26 GHz band to a 29 GHz band, and the frequencies above the 26 GHz band may be collectively referred to as millimeter waves. The alignment state of the liquid crystal molecules of the liquid crystal layer 114 changes in response to the control signal applied to the first patch electrode 108, but hardly follows the frequency of the radio wave incident on the first patch electrode 108. Therefore, the reflector unit cell 102 can control the phase of the reflected radio wave without being affected by the incident radio wave.

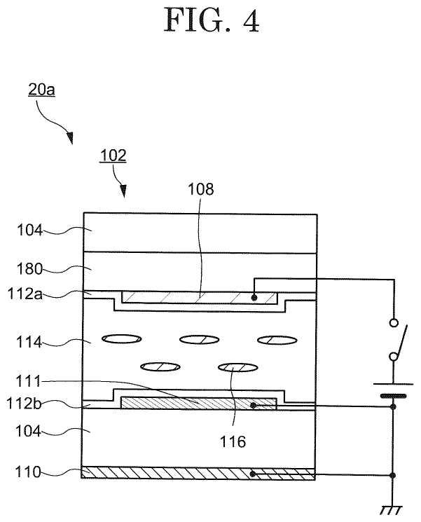

FIG. 4 shows a state in which no voltage is applied between the first patch electrode 108 and the second patch electrode 111 and the electrode layer 110 (referred to as a “first state”). FIG. 4 shows the case where the first alignment film 112a and the second alignment film 112b are horizontal alignment films. The long axis of a liquid crystal molecule 116 in the first state is oriented horizontally with respect to the surfaces of the first patch electrode 108 and the second patch electrode 111 by the first alignment film 112a and the second alignment film 112b. FIG. 5 shows a state in which the control signal (voltage signal) is applied to the first patch electrode 108 (referred to as a “second state”). In the second state, the liquid crystal molecule 116 is affected by an electric field, and the long axis is oriented vertically with respect to the surfaces of the first patch electrode 108 and the second patch electrode 111. The angle at which the long axis of the liquid crystal molecule 116 is oriented may be oriented in a direction intermediate between the horizontal direction and the vertical direction depending on the magnitude of the control signal applied to the first patch electrode 108 (the magnitude of the voltage between the first patch electrode 108 and the second patch electrode 111).

In the case where the liquid crystal molecule 116 has positive dielectric anisotropy, the dielectric constant of the second state is higher than that of the first state. Furthermore, in the case where the liquid crystal molecule 116 has negative dielectric anisotropy, the apparent dielectric constant of the second state is lower than that of the first state. The liquid crystal layer 114 having dielectric anisotropy can also be considered as a variable dielectric layer. The reflector unit cell 102 may be controlled to delay (or not delay) the phase of the reflected wave utilizing the dielectric anisotropy of the liquid crystal layer 114.

FIG. 6 schematically shows that the traveling direction of the reflected wave is changed by any reflector unit cell 102 and the reflector unit cell 102 adjacent thereto. Any reflector unit cell 102 and the reflector unit cell 102 adjacent thereto are adjacent in the direction X. That is, any first patch electrode 108 and the first patch electrode 108 adjacent thereto are connected to different first wirings 118. In addition, any second patch electrode 111 and the second patch electrode 111 adjacent thereto are connected to different first wirings 218. The second patch electrode 111, the second patch electrode 111 adjacent thereto, the first wiring 218 connected to the second patch electrode 111, the first wiring 218 connected to the second patch electrode 111 adjacent thereto, and the electrode layer 110 are electrically connected. In the case where the radio wave is incident on any reflector unit cell 102 and the adjacent reflector unit cell 102 with the same phase, the phase change of the reflected wave by any reflector unit cell 102 is greater than the phase change of the reflected wave by the adjacent reflector unit cell 102 because different control signals (V1≠V2) are applied to any reflector unit cell 102 and the adjacent reflector unit cell 102. As a result, the phase of a reflected wave R1 reflected by any reflector unit cell 102 is different from the phase of a reflected wave R2 reflected by the adjacent reflector unit cell 102 (in FIG. 6, the phase of the reflected wave R2 is ahead of the phase of the reflected wave R1), and apparently, the traveling direction of the reflected wave is changed in an oblique direction.

Further, as shown in FIG. 2, the plurality of reflector unit cells 102 is arranged adjacent to each other in a matrix in the direction D1 and the direction D3. It is preferable to arrange the center of the reflector unit cell 102 (the center O1 of the first patch electrode 108 and the center O2 of the second patch electrode 111) so as to have two or four rotational symmetry. Since the reflector unit cell 102 is arranged to have two rotational symmetry or four rotational symmetry, it is symmetric with respect to the vertically polarized wave and the horizontally polarized wave.

Furthermore, in the display panel integrated radio wave reflecting device 10, the first patch electrode 108 and the second patch electrode 111 are formed using a transparent conductive film. In the display panel integrated radio wave reflecting device 10, since the liquid crystal layer 114 has light transmittance, the radio wave can be reflected without impairing daylight performance. Therefore, the display panel integrated radio wave reflecting device 10 can be installed in windows of high-rise buildings and the like. As a result, it is possible to reflect the radio wave with a high degree of straightness in a predetermined direction at high places with relatively few obstacles. Therefore, the display panel integrated radio wave reflecting device 10 can be used to eliminate a dead zone of radio waves (a place where radio waves do not reach) in an urban area.

### [2-2. Configuration]

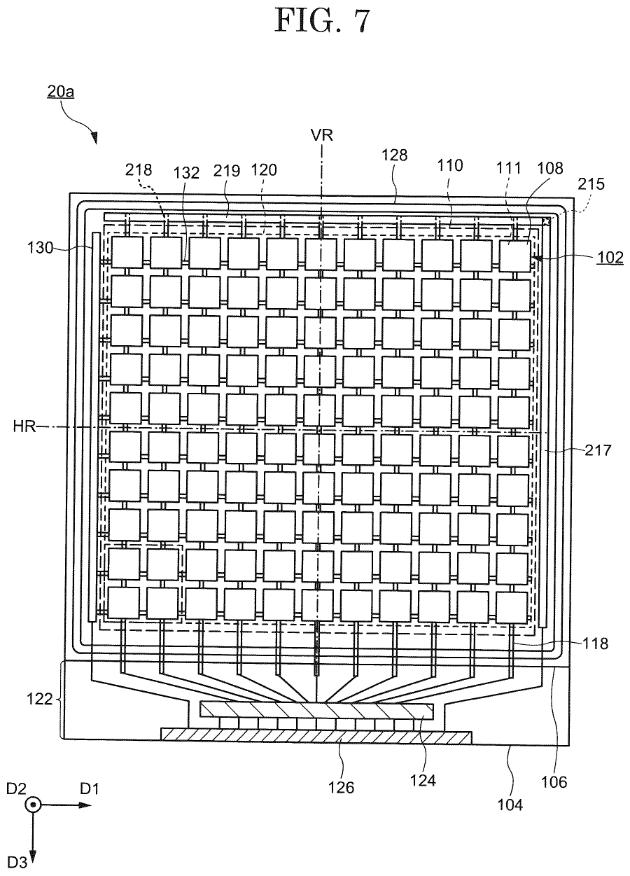

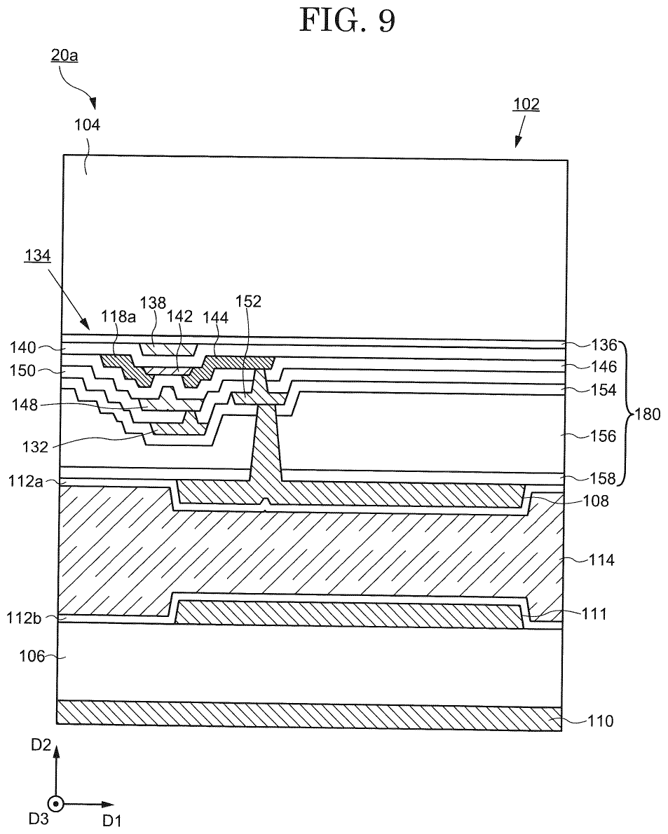

A configuration of the radio wave reflecting part 20a in which the reflector unit cell 102 is integrated will be described with reference to FIG. 7 to FIG. 9. The radio wave reflecting part 20a is a radio wave reflecting part capable of biaxial reflection control. FIG. 7 is a plan view showing a configuration of the display panel integrated radio wave reflecting device 10. 8 is an enlarged plan view of the reflector unit cell 102 shown in FIG. 7. FIG. 9 is a cross-sectional view showing a cut surface of the reflector unit cell 102. The description of the same or similar configurations as those in FIG. 1 to FIG. 6 will be omitted.

As shown in FIG. 7, the reflector 120 has a structure in which the plurality of reflector unit cells 102 is integrated. For example, the plurality of reflector unit cells 102 is arranged in a matrix in the direction D1 and the direction D3.

The first patch electrode 108 and the second patch electrode 111 are arranged so as to face the incident surface of the radio wave, in the reflector unit cell 102. The electrode layer 110 has a flat plate shape. The plurality of first patch electrodes 108 and the plurality of second patch electrodes 111 are arranged in a matrix in the plane of the flat plate-shaped electrode layer 110 and a region inside the sealing material 128.

A plurality of first wirings 118 extending in the direction D3 is arranged in the dielectric substrate 104. A plurality of first wirings 218 is arranged in the counter substrate 106. The first wiring 118 and the first wiring 218 are stacked in the direction D2 and overlap each other. In addition, the plurality of overlapping first wirings 118 and 218 are arranged in the direction D1. The reflector 120 has a configuration in which a plurality of patch electrode arrays connected by the overlapping first wirings 118 and a plurality of patch electrode arrays connected by the first wiring 218 are arranged in a row in a direction Y.

In the dielectric substrate 104, a region other than the reflector 120 is referred to as a peripheral region 122. A first drive circuit 124 and a terminal portion 126 are provided in the peripheral region 122. The terminal portion 126 is a region that forms a connection with an external circuit, and for example, a flexible printed circuit (not shown) is connected to the terminal portion 126. A signal for controlling the first drive circuit 124 is input to the terminal portion 126 from the flexible printed circuit.

The plurality of first wirings 118 arranged in the dielectric substrate 104 extends in the direction Y and extends in the peripheral region 122 and is connected to the first drive circuit 124. The plurality of first wirings 218 arranged in the counter substrate 106 is connected to a ground wiring 219 extending in the direction Y and arranged on the opposite side of the terminal portion 126. The ground wiring 219 is electrically connected via a connecting part 215 to a ground wiring 217 arranged in the dielectric substrate 104. The ground wiring 217 extends to the peripheral region 122 and is connected to the first drive circuit 124.

The first drive circuit 124 outputs the control signal to the first patch electrode 108 via the first wiring 118. The first drive circuit 124 outputs the control signal to the second patch electrode 111 via the first wiring 218, the ground wiring 217, the connecting part 215, and the ground wiring 219. The first drive circuit 124 may be configured to output control signals of different voltage levels to each of the plurality of first wirings 118 and the plurality of first wirings 218. For example, the control signals of different voltage levels are a control signal of a first voltage level and a control signal of a second voltage level. For example, the control signal of the second voltage level is the ground voltage.

A plurality of second wirings 132 extending in the direction X arranged on the reflector 120 extends in the direction X and is connected to the second drive circuit 130. The second drive circuit 130 outputs a scan signal to the plurality of second wirings 132.

FIG. 8 shows an enlarged view of the arrangement of the first patch electrode 108, the first wiring 118, and the second wiring 132. The switching element 134 is provided on the first patch electrode 108. The switching (on/off) of the switching element 134 is controlled by the scan signal applied to the second wiring 132. In response to the scan signal applied to the second wiring 132, the first patch electrode 108 having the switching element 134 turned on is electrically connected to the first wiring 118, and the control signal is applied thereto. In response to the scan signal applied to the second wiring 132, the first patch electrode 108 having the switching element 134 turned on is electrically connected to the first wiring 118, and the control signal is applied thereto. For example, the switching element 134 is formed of a thin film transistor. According to such a configuration, the plurality of first patch electrodes 108 arranged in the direction D1 can be selected for each row, and control signals of different voltage levels can be applied to each row.

The radio wave reflecting part 20a can control the radio wave incident on the reflector 120 so as to be able to control the traveling direction of the reflected wave in the left-right direction of the drawing with a reflection axis VR parallel to the direction Y as the center, and can also control the traveling direction of the reflected wave in the up-down direction of the drawing with a reflection axis HR parallel to the direction X as the center. That is, the radio wave reflecting part 20a includes the reflection axis VR parallel to the direction Y and a reflecting axis VH parallel to the direction X and can control the reflecting angle in a direction with the reflection axis VR as the rotation axis and a direction with the reflection axis HR as the rotation axis.

FIG. 9 shows an example of a cross-sectional structure of the reflector unit cell 102 in which the switching element 134 is connected to the first patch electrode 108. The switching element 134 is provided on the dielectric substrate 104. The switching element 134 is a transistor. The switching element 134 includes a structure in which a first gate electrode 138, a first gate insulating layer 140, a semiconductor layer 142, a second gate insulating layer 146, and a second gate electrode 148 are stacked. An undercoat layer 136 may be provided between the first gate electrode 138 and the dielectric substrate 104. The first wiring 118 is provided between the first gate insulating layer 140 and the second gate insulating layer 146. The first wiring 118 is provided in contact with the semiconductor layer 142. In addition, a first connection wiring 144 is provided in the same conductive layer as the conductive layer forming the first wiring 118. The first connection wiring 144 is provided in contact with the semiconductor layer 142. The connection structure of the first wiring 118 and the first connection wiring 144 to the semiconductor layer 142 shows a structure in which one wiring is connected to a source of the transistor and the other wiring is connected to a drain.

A first interlayer insulating layer 150 is provided to cover the switching element 134. The second wiring 132 is provided on the first interlayer insulating layer 150. The second wiring 132 is connected to the second gate electrode 148 via a contact hole formed in the first interlayer insulating layer 150. Although not shown, the first gate electrode 138 and the second gate electrode 148 are electrically connected to each other in a region that does not overlap the semiconductor layer 142. A second connection wiring 152 is provided on the first interlayer insulating layer 150 in the same conductive layer as the second wiring 132. The second connection wiring 152 is connected to the first connection wiring 144 via the contact hole formed in the first interlayer insulating layer 150.

A second interlayer insulating layer 154 is provided to cover the second wiring 132 and the second connection wiring 152. In addition, a planarization layer 156 is provided to fill a step involved in forming the switching element 134. By providing the planarization layer 156, the step of the switching element 134 can be filled, and the surface of the planarization layer 156 becomes flat. Therefore, the first patch electrode 108 can be formed on the flat surface of the planarization layer 156 without being affected by the step of the switching element 134. A passivation layer 158 is provided on the flat surface of the planarization layer 156. In the display panel integrated radio wave reflecting device 10, for example, the array layer 180 includes the undercoat layer 136, a conductive layer including the first gate electrode 138, a first gate insulating layer 140, the semiconductor layer 142, a conductive layer including the first connection wiring 144, the second gate insulating layer 146, a conductive layer including the second gate electrode 148, the first interlayer insulating layer 150, a conductive layer including the second connection wiring 152, the second interlayer insulating layer 154, the planarization layer 156, and the passivation layer 158. The array layer 180 may include a conductive layer that forms the first patch electrode 108 provided in a contact hole that penetrates the passivation layer 158, the planarization layer 156, and the second interlayer insulating layer 154.

The first patch electrode 108 is provided on the passivation layer 158. The first patch electrode 108 is connected to the second connection wiring 152 via the contact hole that penetrates the passivation layer 158, the planarization layer 156, and the second interlayer insulating layer 154. The first alignment film 112a is provided on the first patch electrode 108.

Similar to the structure of the cut surfaces shown in FIG. 1 and FIG. 3, the second patch electrode 111 and the second alignment film 112b are provided on the second main surface 101B of the counter substrate 106. Similar to the structure of the cut surfaces shown in FIG. 1 and FIG. 3, the electrode layer 110 is provided on the first main surface 101A of the counter substrate 106. The surface of the dielectric substrate 104 on which the switching element 134 and the first patch electrode 108 are provided is arranged so as to face the surface of the counter substrate 106 on which the second patch electrode 111 and the second alignment film 112b are provided, and the liquid crystal layer 114 is provided between the surface on which the switching element 134 and the first patch electrode 108 are provided and the surface on which the second patch electrode 111 is provided.

Each layer formed on the dielectric substrate 104 is formed using the following materials. For example, the undercoat layer 136 is formed of a silicon oxide film. For example, the first gate insulating layer 140 and the second gate insulating layer 146 are formed of a silicon oxide film or a stacked structure of a silicon oxide film and a silicon nitride film. The semiconductor layer is formed of a silicon semiconductor such as polycrystalline silicon, and an oxide semiconductor containing metallic oxides such as indium oxide, zinc oxide, and gallium oxide. For example, the first gate electrode 138 and the second gate electrode 148 may be composed of molybdenum (Mo), tungsten (W), or an alloy thereof. The first wiring 118, the second wiring 132, the first connection wiring 144, and the second connection wiring 152 are formed using a metallic material such as titanium (Ti), aluminum (Al), or molybdenum (Mo). For example, a stacked structure of titanium (Ti)/aluminum (Al)/titanium (Ti), or a stacked structure of molybdenum (Mo)/aluminum (Al)/molybdenum (Mo) may be used. The planarization layer 156 is formed of a resin material such as acrylic or polyimide. For example, the passivation layer 158 is formed of a silicon nitride film. The first patch electrode 108, the second patch electrode 111, and the electrode layer 110 are formed of a metallic film such as aluminum (Al) or copper (Cu), or a transparent conductive film such as indium tin oxide (ITO).

As shown in FIG. 9, by connecting the second wiring 132 to the gate of the transistor used as the switching element 134, connecting the first wiring 118 to one of the source and the drain of the transistor, and connecting the first patch electrode 108 to the other of the source and the drain, a predetermined patch electrode can be selected from the plurality of first patch electrodes 108 arranged in a matrix, and the control signal can be applied. By providing the switching element 134 in each of the first patch electrodes 108 in the reflector 120, the control voltage can be applied to each of the first patch electrodes 108 arranged in a horizontal row parallel to the direction D1 or each of the first patch electrodes 108 arranged in a vertical row parallel to the direction D3. For example, when the reflector 120 is upright, the reflection direction of the reflected wave can be controlled in the left-right direction and the up-down direction.

### [3. Display Panel Part 30]

### [3-1. Overview]

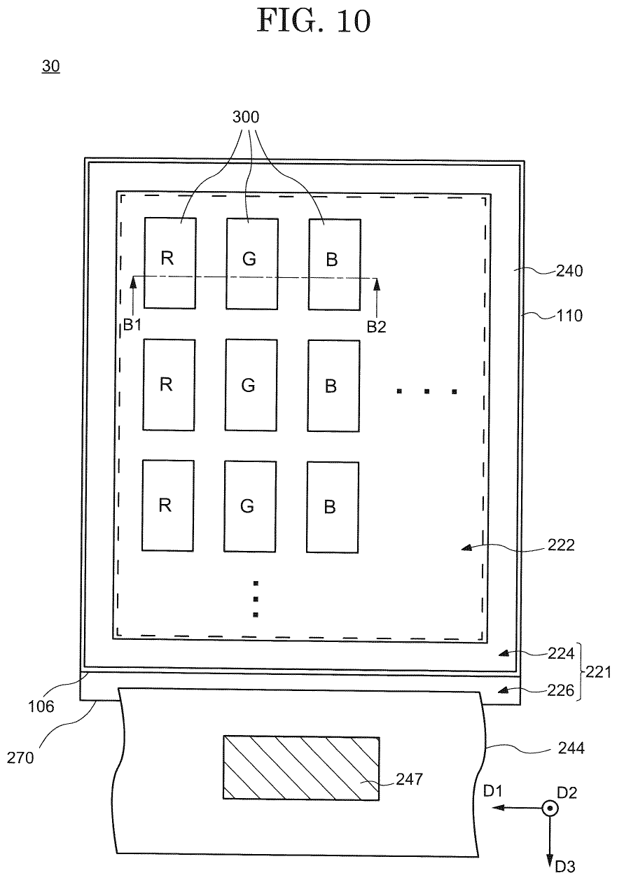

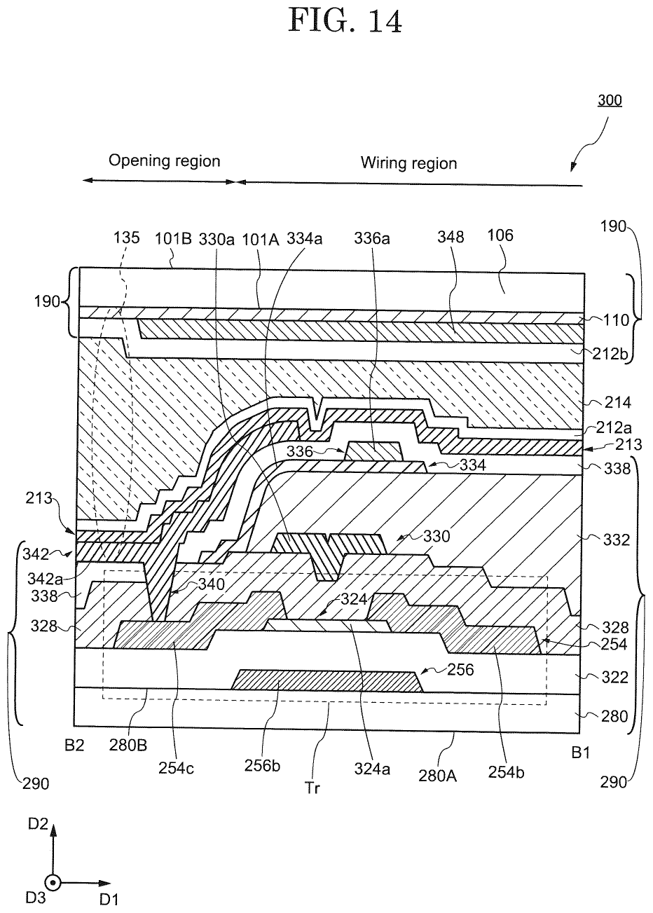

An overview of the display panel part 30 used in the display panel integrated radio wave reflecting device 10 according to an embodiment of the present invention will be described with reference to FIG. 1, FIG. 10, and FIG. 14. The description of the same or similar configurations as those in FIG. 1 to FIG. 9 will be omitted.

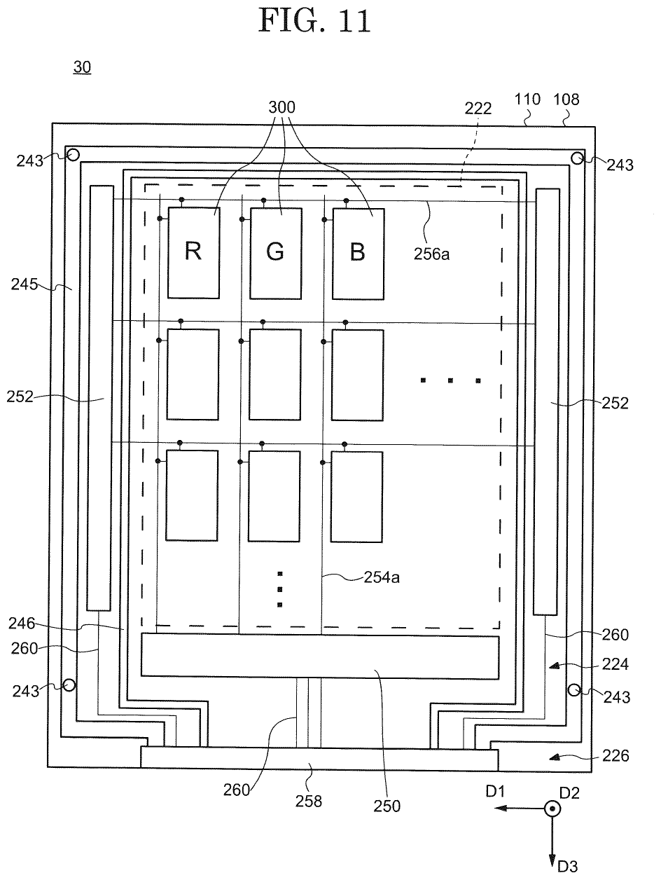

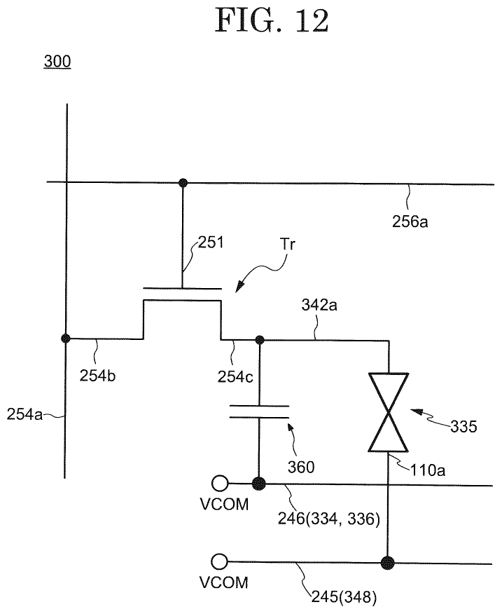

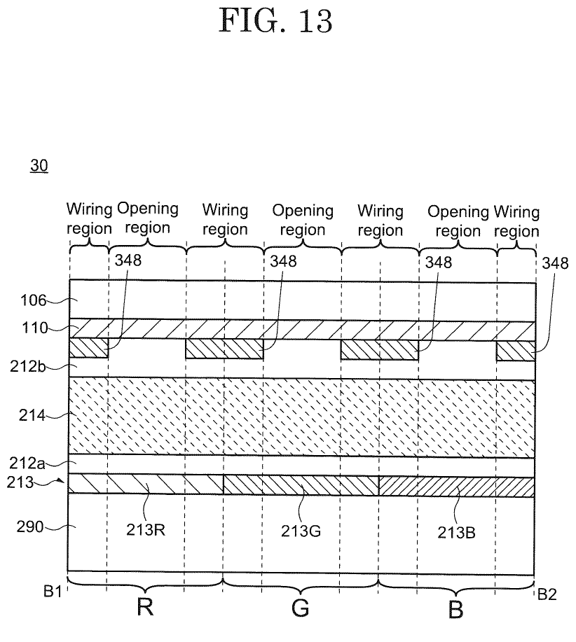

FIG. 10 and FIG. 11 are top views showing a configuration of the display panel part 30. FIG. 12 is a circuit diagram showing a circuit configuration of a pixel 300 of the display panel part 30. FIG. 13 is a cross-sectional view illustrating a cross-sectional structure of the pixel 300 along the line B1-B2 shown in FIG. 10. FIG. 14 is a cross-sectional view showing a cross-sectional structure of the pixel 300 shown in FIG. 10.

As described with reference to FIG. 1 in “1. Overview of Display Panel Integrated Radio Wave Reflecting Device 10,” the display panel part 30 includes the array substrate 270, the third alignment film 212a, the liquid crystal layer 214, the sealing material 228, the fourth alignment film 212b, the electrode layer 110, and the counter substrate 106.

In addition, as shown in FIG. 10, the display panel part 30 includes the array substrate 270, a sealing portion 240, the counter substrate 106, a flexible printed circuit board 244 (FPC 244), and a control circuit 247. The array substrate 270 and the counter substrate 106 are bonded by the sealing portion 240. In a display region 222 surrounded by the sealing portion 240, a plurality of pixels 300 is arranged in a matrix in the direction D1 and the direction D2. The display region 222 is a region that overlaps the liquid crystal layer 214 described later in a plan view.

A peripheral region 221 includes a sealing region 224 and a terminal region 226. The peripheral region 221 surrounds the display region 222 and is a region around the display region 222. The sealing region 224 is a region around the display region 222 that overlaps the sealing portion 240 in a plan view. The terminal region 226 is a region in which the array substrate 270 is exposed from the counter substrate 106 and is provided outside the sealing region 224. In addition, the outside of the sealing region 224 means the outside of the region surrounded by the sealing portion 240. The FPC 244 is provided in the terminal region 226. The control circuit 247 is provided on the FPC 244. The control circuit 247 supplies a control signal for driving each pixel 300.

### [3-2. Configuration]

As shown in FIG. 11, a source driver circuit 250 is provided parallel to the direction D1 of the display region 222 in which the pixel 300 is provided, and a gate driver circuit 252 is provided parallel to the direction D2. The source driver circuit 250 and the gate driver circuit 252 are provided in the sealing region 224.

For example, the arrangement of the plurality of pixels 300 is a stripe arrangement. For example, each of the plurality of pixels 300 may correspond to a sub-pixel R, a sub-pixel G, and a sub-pixel B. One pixel may be formed by three sub-pixels. The pixel 300 is the smallest unit constituting a part of the images reproduced in the display region 222. Each sub-pixel includes one display element. The display element is a liquid crystal element 335, in the example shown in FIG. 10. The color to which the sub-pixel corresponds is determined by the characteristics of the liquid crystal element 335 or a color filter (not shown) provided in the sub-pixel.

The sub-pixel R, the sub-pixel G, and the sub-pixel B can be configured to exhibit different colors in the stripe arrangement. For example, the sub-pixel R, the sub-pixel G, and the sub-pixel B may each include a color filter that emits three primary colors red, green, and blue. For example, the sub-pixel R may include a red color filter 213R that emits red (see FIG. 13), the sub-pixel G may include a green color filter 213G that emits green (see FIG. 13), and the sub-pixel B may include a blue color filter 213B that emits blue (see FIG. 13). Any voltage or current is supplied to each of the three sub-pixels, and the display panel part 30 can display images.

A distance WR between the adjacent sub-pixels R and G, a distance WG between the adjacent sub-pixels G and B, and a distance WB between the adjacent sub-pixels B and R may be the same or different. For example, the distance WR, the distance WG, and the distance WB can be selected from a range of 200 μm to 500 μm. For example, the distance WR, the distance WG, and the distance WB may be referred to as pixel pitches, in the display panel integrated radio wave reflecting device 10. The distance WR, the distance WG, and the distance WB (pixel pitches) are smaller than the pitch of the reflector unit cell 102.

A signal line 254a extends in the direction D2 from the source driver circuit 250 and is connected to the plurality of pixels 300 arranged in the direction D2. A scanning line 256a extends in the direction D1 from the gate driver circuit 252 and is connected to the plurality of pixels 300 arranged in the direction D1.

A terminal portion 258 is provided in the terminal region 226. The terminal portion 258 and the source driver circuit 250 are connected by a connecting wiring 260. Similarly, the terminal portion 258 and the gate driver circuit 252 are connected by the connecting wiring 260. When the FPC 244 is connected to the terminal portion 258, the external device to which the FPC 244 is connected is connected to the display panel part 30, and a signal from the external device is supplied to, for example, the control circuit 247, the source driver circuit 250, the gate driver circuit 252, and the respective pixels 300. The display panel part 30 drives each pixel 300 provided in the display panel part 30 using signals from the external device and the control signal generated by the control circuit 247, the source driver circuit 250, and the gate driver circuit 252.

### [3-3. Configuration of Pixel 300]

FIG. 12 is a circuit diagram showing a circuit configuration of the pixel 300. FIG. 13 is a cross-sectional view showing a cross-sectional structure of the pixel 300 along a line B1-B2 shown in FIG. 10. FIG. 14 is a cross-sectional view showing a cross-sectional structure of the pixel 300. The description of the same or similar configurations as those in FIG. 1 to FIG. 11 may be omitted.

For example, as shown in FIG. 12, the pixel 300 includes a transistor Tr, the liquid crystal element 335, and a capacitance element 360. The transistor Tr includes a gate electrode 251, a source electrode 254b, and a drain electrode 254c. The gate electrode 251 is electrically connected to the scanning line 256a. The source electrode 254b is electrically connected to the signal line 254a. The drain electrode 254c is electrically connected to a pixel electrode 342a. The capacitance element 360 is electrically connected between the pixel electrode 342a (drain electrode 254c) and a capacitance wiring 246. The liquid crystal element 335 includes the pixel electrode 342a (drain electrode 254c), a common electrode 110a, and the liquid crystal layer 214. The common electrode 110a is electrically connected to a common wiring 245. The electrode layer 110 includes the common electrode 110a. For example, the capacitance wiring 246 and the common wiring 245 are supplied with a common voltage VCOM from the control circuit 247. Since the common wiring 245 is electrically connected to the electrode layer 110 via a plurality of connecting parts 243, the liquid crystal element 335 is electrically connected to the electrode layer 110. The display panel part 30 may change the alignment state of the liquid crystal molecules (not shown) contained in the liquid crystal element 335 by supplying a current or voltage to each of the pixel electrode 342a and the electrode layer 110. As a result, the display panel part 30 can display images.

For example, the control circuit 247 supplies the common voltage VCOM to the electrode layer 110 via the common wiring 245 and the plurality of connecting parts 243. For example, the common voltage VCOM may be the ground voltage (GND voltage) or may be a voltage of 0 V. Therefore, the display panel part 30 can supply the common voltage VCOM to the electrode layer 110 with respect to the display panel part 30, and can supply the ground voltage to the electrode layer 110 with respect to the radio wave reflecting part 20a. That is, in association with the sharing of the electrode layer 110 by the radio wave reflecting part 20a and the display panel part 30, the display panel integrated radio wave reflecting device 10 can supply a voltage only from the display panel part 30 to the electrode layer 110 instead of supplying a voltage from both the radio wave reflecting part 20a and the display panel part 30 to the electrode layer 110. Therefore, the display panel integrated radio wave reflecting device 10 can combine the two paths for supplying the voltage to the electrode layer 110 into one. As a result, the configuration of the display panel integrated radio wave reflecting device 10 can be simplified and the manufacturing cost can be reduced as compared with the case where the voltage is supplied from both the radio wave reflecting part 20a and the display panel part 30 to the electrode layer 110.

As shown in FIG. 13 or FIG. 14, a substrate 280 includes a first main surface 280A and a second main surface 280B. A first conductive layer 256, an insulating layer 322, a semiconductor layer 324, and a second conductive layer 254 are arranged in this order on the second main surface 280B of the substrate 280.

The first conductive layer 256 includes the scanning line 256a (see FIG. 11) and a first conductive film 256b. The semiconductor layer 324 includes a semiconductor film 324a. The second conductive layer 254 includes the signal line 254a, the source electrode 254b, and the drain electrode 254c.

The transistor Tr is provided on the second main surface 280B. The transistor Tr includes the semiconductor film 324a provided to face the first conductive film 256b, the insulating layer 322 provided between the first conductive film 256b and the semiconductor film 324a, the source electrode 254b provided on the semiconductor film 324a, and the drain electrode 254c.

The insulating layer 322 provided between the first conductive film 256b and the semiconductor film 324a functions as a gate insulating film of the transistor Tr. The first conductive film 256b is electrically connected to the scanning line 256a and functions as the gate electrode 251. The source electrode 254b is electrically connected to the signal line 254a and functions as a source electrode. A region where the semiconductor film 324a overlaps the first conductive film 256b (gate electrode) is a channel region of the transistor Tr. The semiconductor film 324a may have a source region and a drain region so as to sandwich the channel region. The source electrode or drain electrode may be formed in the source region or drain region.

An insulating layer 328 and a third conductive layer 330 are arranged in this order on the transistor Tr. The third conductive layer 330 includes a third conductive film 330a. The third conductive film 330a is disposed on the insulating layer 328 at a position facing the semiconductor film 324a. The third conductive film 330a functions as a back gate electrode. The transistor Tr of the display panel part 30 has a bottom-gate configuration as an example. The configuration of the transistor Tr is not limited to the bottom-gate configuration, and may be a top-gate configuration or a dual-gate configuration.

An insulating layer 332 is arranged on the third conductive layer 330 and the insulating layer 328. In the display panel integrated radio wave reflecting device 10, the display panel part 30 is a reflective liquid crystal display panel that uses a liquid crystal similar to the liquid crystal layer 114. Generally, in the liquid crystal display panel, the number of layers that absorb light is preferably small. Therefore, in an opening region of the pixel 300, the insulating layer 332 is preferably removed. As a result, the display panel part 30 can suppress the insulating layer 332 from absorbing light in the opening region. Furthermore, in the display panel part 30, a region other than the opening region includes wirings such as the signal line 254a, the scanning line 256a, and the capacitance wiring 246, and is referred to as a wiring region.

A transparent conductive layer 334 and a fourth conductive layer 336 are arranged in this order on the insulating layer 332 and the insulating layer 328. The transparent conductive layer 334 includes a transparent conductive film 334a, and the fourth conductive layer 336 includes a fourth conductive film 336a. The transparent conductive film 334a and the fourth conductive film 336a are electrically connected to the capacitance wiring 246 (see FIG. 11 or FIG. 12) in the display region 222 and the peripheral region 221. The fourth conductive film 336a is formed in contact with the transparent conductive film 334a.

An insulating layer 338 is arranged on the transparent conductive layer 334 and the fourth conductive layer 336. A pixel electrode layer 342 is arranged on the insulating layer 338. For example, a color filter layer 213 is arranged on the insulating layer 338 and the pixel electrode layer 342. The color filter layer 213 includes the red color filter 213R, the green color filter 213G, and the blue color filter 213B as an example. The third alignment film 212a is arranged on the color filter layer 213. The pixel electrode layer 342 includes the pixel electrode 342a. The pixel electrode 342a is electrically connected to the drain electrode 254c via an opening part 340 that penetrates the insulating layer 328 and the insulating layer 338.

The counter substrate 106 includes the first main surface 101A and the second main surface 101B. The counter substrate 106 is arranged to face the substrate 280. Specifically, the second main surface 101B of the counter substrate 106 is arranged to face the second main surface 280B of the substrate 280. The electrode layer 110 and a black matrix 348 are provided on the second main surface 101B of the counter substrate 106. The black matrix 348 is formed in contact with the electrode layer 110. The fourth alignment film 212b is arranged on the electrode layer 110 and the black matrix 348. The electrode layer 110 in the first embodiment is arranged on the entire surface of the second main surface 101B. The electrode layer 110 is electrically connected to the common wiring 245 in the peripheral region 221 via the plurality of connecting parts 243 (see FIG. 11). The black matrix 348 is arranged in a grid pattern in the display region 222 and the peripheral region 221. The liquid crystal layer 214 is sandwiched between the substrate 280 and the counter substrate 106 and sealed by the sealing portion 240 (see FIG. 2). The thickness between the substrate 280 and the counter substrate 106 is the thickness of the liquid crystal layer 214. In the display panel part 30, the liquid crystal element 335 includes the pixel electrode layer 342, the liquid crystal layer 214, and the electrode layer 110. For example, the thickness of the liquid crystal layer 214 is 2.0 μm or more and 5 μm or less.

For example, the first conductive layer 256, the second conductive layer 254, the third conductive layer 330, the fourth conductive layer 336, and the electrode layer 110 may be formed of a metal such as aluminum (Al), titanium (Ti), molybdenum (Mo), copper (Cu), or tungsten (W), or an alloy thereof. In addition, the first conductive layer 256, the second conductive layer 254, the third conductive layer 330, the fourth conductive layer 336, and the electrode layer 110 may be a single layer or a stacked layer.

The electrode layer 110 of the display panel integrated radio wave reflecting device 10 reflects radio waves and functions as the ground electrode with respect to the radio wave reflecting part 20a. In addition, the electrode layer 110 reflects light and functions as the common electrode with respect to the display panel part 30. Therefore, the material forming the electrode layer 110 is preferably a material with high reflectivity and low resistivity.

The insulating layer 322 may separate the semiconductor layer 324 from the first conductive layer 256, so that the semiconductor layer 324 and the first conductive layer 256 do not short-circuit. For example, an inorganic insulating material such as silicon oxide (SiOₓ), silicon oxynitride (SiOₓN_{y}), silicon nitride (SiNₓ), or silicon nitride oxide (SiNₓO_{y}) can be used as the material for forming the insulating layer 322. In this case, SiOₓN_{y} is a silicon compound containing less nitrogen (N) than oxygen (O). SiNₓO_{y} is a silicon compound containing less oxygen than nitrogen.

The insulating layer 332 is arranged on an unevenness caused by the transistor Tr or other semiconductor elements and has a function of forming a flat surface. An organic compound material selected from acrylics, polyimides, and the like, which has excellent flatness properties, can be used as a material for forming the insulating layer 332.

The insulating layer 328 may separate the semiconductor layer 324 and the second conductive layer 254 from the third conductive layer 330, so that the semiconductor layer 324, the second conductive layer 254, and the third conductive layer 330 do not short-circuit. For example, a material similar to that of the insulating layer 322, an inorganic insulating material such as aluminum oxide (AlOₓ), aluminum oxynitride (AlOₓN_{y}), aluminum nitride oxide (AlNₓO_{y}), or aluminum nitride (AlNₓ) can be used as a material for forming the insulating layer 328. In this case, AlOₓN_{y} is an aluminum compound containing less nitrogen (N) than oxygen (O). AlNₓO_{y} is an aluminum compound containing less oxygen than nitrogen. The insulating layer 328 may be formed using the inorganic insulating material alone or stacking these materials.

The insulating layer 338 may separate the transparent conductive layer 334 and the fourth conductive layer 336 from the pixel electrode layer 342, so that the transparent conductive layer 334, the fourth conductive layer 336, and the pixel electrode layer 342 do not short-circuit. The insulating layer 338 is formed of a material similar to that of the insulating layer 328 and has a similar configuration.

For example, a transparent conductive material such as indium tin oxide (ITO) or indium zinc oxide (IZO) can be used as a material for forming the transparent conductive layer 334 and the pixel electrode layer 342.

A black resin or a metal material can be used as a material for forming the black matrix 348. The metal material may be chromium, molybdenum, or titanium, which have a relatively low reflectance compared with aluminum. In the display panel part 30, the common electrode is formed by the black matrix 348 and the electrode layer 110. As a result, in the common electrode of the display panel part 30, the black matrix 348 can function as an auxiliary electrode with low resistance loss.

An array substrate 290 includes the substrate 280, the first conductive layer 256, the insulating layer 322, the semiconductor layer 324, the second conductive layer 254, the insulating layer 328, the third conductive layer 330, the insulating layer 332, the transparent conductive layer 334, the fourth conductive layer 336, the insulating layer 338, and the pixel electrode layer 342. The array substrate 290 may include the color filter layer 213 and the third alignment film 212a.

A substrate 190 includes the counter substrate 106, the electrode layer 110, the black matrix 348, and the fourth alignment film 212b. The substrate 190 may be referred to as a counter substrate.

### [4. Usage Example of Display Panel Integrated Radio Wave Reflecting Device 10]

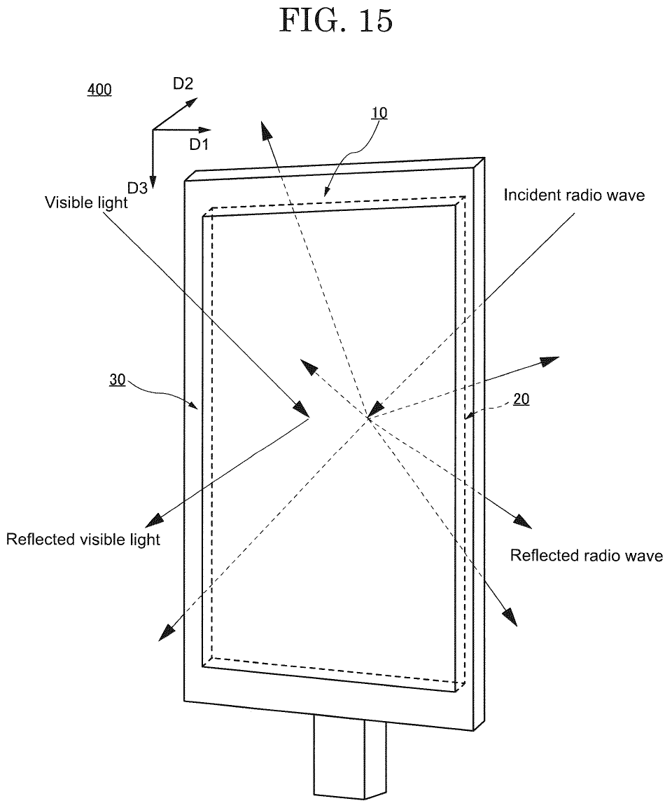

A usage example of the display panel integrated radio wave reflecting device 10 will be described with reference to FIG. 15. FIG. 15 is a perspective view showing the usage example of the display panel integrated radio wave reflecting device 10 for an electronic signboard 400. The description of the same or similar configurations as those in FIG. 1 to FIG. 14 may be omitted.

As shown in FIG. 15, the electronic signboard 400 includes the display panel integrated radio wave reflecting device 10 including the radio wave reflecting part 20a and the display panel part 30. In the example shown in FIG. 15, the display panel integrated radio wave reflecting device 10 is mounted on the electronic signboard 400 so that the display panel part 30 is positioned on the front surface side of the electronic signboard 400 and the radio wave reflecting part 20a is positioned on the back surface side of the electronic signboard 400.

As shown in FIG. 15, the radio wave corresponding to the 5G standard communication is reflected toward the traveling direction of the reflected radio wave with respect to the traveling direction of the incident wave (incident radio wave), in the radio wave reflecting part 20a on the back surface of the display panel integrated radio wave reflecting device 10. Furthermore, visible light is reflected toward the traveling direction of the reflected visible light with respect to the traveling direction of the visible light, in the display panel part 30 on the front surface side of the display panel integrated radio wave reflecting device 10.

For example, visible light is an electromagnetic wave visible to the human eye as light and includes light in the range of wavelengths of 380 nm to 810 nm. For example, visible light may include wavelengths ranging from 430 nm to 490 nm exhibiting a blue color, wavelengths ranging from 490 nm to 550 nm exhibiting a green color, and wavelengths ranging from 640 nm to 810 nm exhibiting a red color.

For example, a public space, such as a square in front of a station, is a place where people who own an information terminal gather. A plurality of electronic signboards 400 is installed in the public space so that radio waves are reflected in the public space and images are displayed on the side where the people pass by.

The display panel part 30 and the radio wave reflecting part 20a are integrally provided on the front and back sides, in the display panel integrated radio wave reflecting device 10. As a result, the display panel part 30 and the radio wave reflecting part 20a can be installed in the same place even in a place where the installation of the display panel part 30 or the radio wave reflecting part 20a compete.

### Second Embodiment

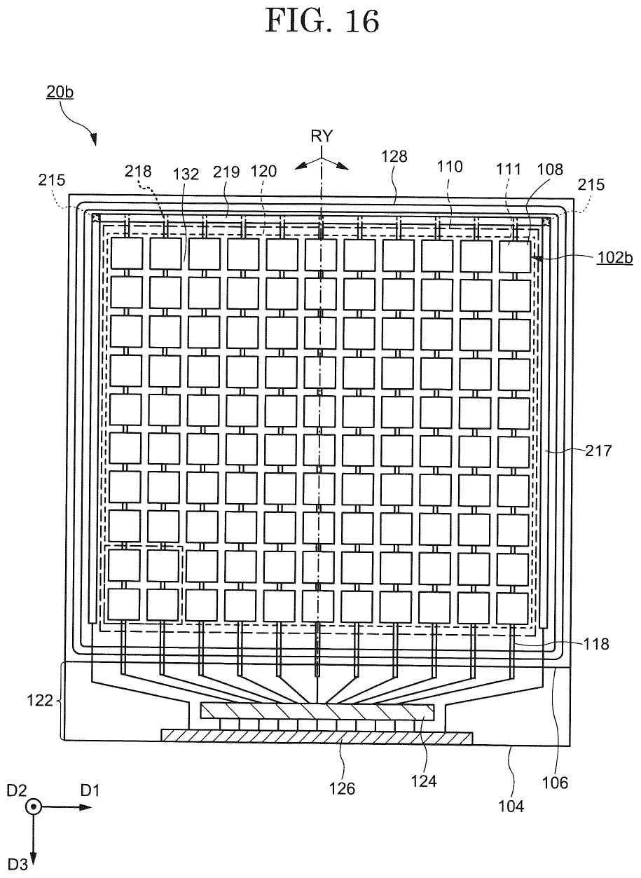

In the second embodiment, the display panel integrated radio wave reflecting device 10 including an uniaxially controllable radio wave reflecting part 20b will be described. A reflection axis RY of the radio wave reflecting part 20b is uniaxial. The reflection angle can be controlled with the reflection axis RY as the rotation axis, in the display panel integrated radio wave reflection device 10 including the radio wave reflecting part 20b. The display panel integrated radio wave reflecting device 10 according to the second embodiment is a device in which the radio wave reflecting part 20a of the display panel integrated radio wave reflecting device 10 according to the first embodiment is replaced with the radio wave reflecting part 20b. The display panel integrated radio wave reflecting device 10 according to the second embodiment does not include at least the array layer 180, the plurality of second wirings 132, and the second drive circuit 130 with respect to the radio wave reflecting part 20a of the display panel integrated radio wave reflecting device 10 according to the first embodiment. In the second embodiment, differences from the first embodiment will be mainly described with reference to FIG. 16 to FIG. 18.

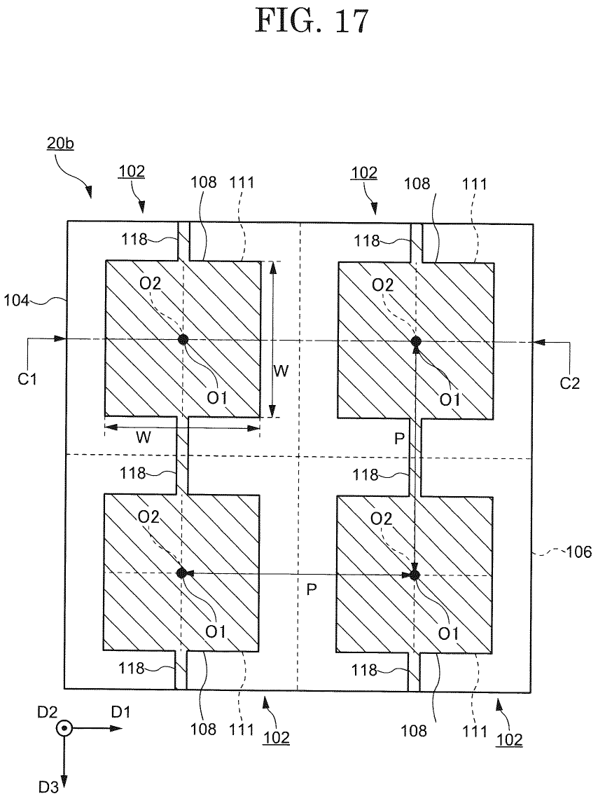

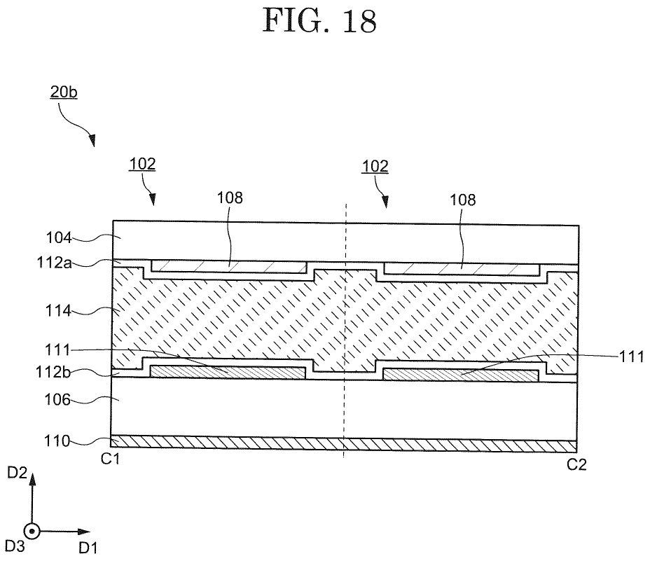

FIG. 16 is a plan view showing a configuration of the radio wave reflecting part 20b according to the second embodiment. FIG. 17 is a plan view showing a reflector unit cell 102b used in the radio wave reflecting part 20b. FIG. 18 is a cross-sectional view showing a cut surface of a line C1-C2 shown in FIG. 17. The description of the same or similar configurations as those in FIG. 1 to FIG. 5 will be omitted.

As shown in FIG. 16, the reflector 120 according to the second embodiment includes a plurality of reflector unit cells 102b. The reflector 120 according to the second embodiment includes a configuration in which the plurality of reflector unit cells 102 of the reflector 120 according to the first embodiment is replaced with the plurality of reflector unit cells 102b.

Similar to the reflector 120 described in the first embodiment, the reflector 120 according to the second embodiment is provided between the dielectric substrate 104 and the counter substrate 106. As shown in FIG. 16 and FIG. 17, the reflector 120 according to the second embodiment has a configuration in which the plurality of reflector unit cells 102b is integrated.

Various configurations of the display panel integrated radio wave reflecting device exemplified as an embodiment of the present invention can be appropriately combined and implemented as long as no contradiction is caused. Furthermore, the addition, deletion, or design change of components, or the addition, deletion, or condition change of processes as appropriate by those skilled in the art based on the display panel integrated radio wave reflecting device disclosed in the specification and the drawings are also included in the scope of the present invention as long as they are provided with the gist of the present invention.

Further, it is understood that, even if the effect is different from those provided by each of the above-described embodiments, the effect obvious from the description in the specification or easily predicted by persons ordinarily skilled in the art is apparently derived from the present invention.

What is claimed is:

1. An intelligent reflecting surface comprising:
a plurality of first patch electrodes;
a plurality of second patch electrodes facing and spaced apart from the plurality of first patch electrodes;
an electrode layer facing and spaced apart from the plurality of second patch electrodes on the side opposite the side on which the plurality of first patch electrodes is provided with respect to the plurality of second patch electrodes;
a first liquid crystal layer provided between the plurality of first patch electrodes and the plurality of second patch electrodes;
a first substrate provided between the plurality of second patch electrodes and the electrode layer;
an array substrate provided on the side opposite the side on which the first substrate is provided with respect to the electrode layer, the array substrate including a plurality of transistors; and
a second liquid crystal layer provided between the array substrate and the electrode layer.

2. The intelligent reflecting surface according to claim 1, further comprising,
a radio wave reflecting part; and
a display panel part,
wherein
the radio wave reflecting part includes the plurality of first patch electrodes, the plurality of second patch electrodes, the first liquid crystal layer, the electrode layer, and the first substrate, and
the display panel part includes the array substrate, the second liquid crystal layer, the electrode layer, and the first substrate.

3. The intelligent reflecting surface according to claim 2, wherein
the first substrate includes a first main surface and a second main surface opposite the first main surface,
the electrode layer is arranged on the first main surface,
the radio wave reflecting part is configured to reflect radio waves incident from the side where the plurality of first patch electrodes is provided, and
the display panel part is configured to reflect visible light incident from the array substrate toward the electrode layer.

4. The intelligent reflecting surface according to claim 3, wherein
the radio wave is a radio wave corresponding to 5G standard communication, and
the visible light includes light having a wavelength range of 380 nm to 810 nm.

5. The intelligent reflecting surface according to claim 3, wherein
the radio wave reflecting part includes a plurality of reflector unit cells arranged in a matrix in a first direction and a third direction intersecting the first direction,
the plurality of reflector unit cells includes a first reflector unit cell and a second reflector unit cell adjacent to the first reflector unit cell,
each of the first reflector unit cell and the second reflector unit cell includes the first patch electrode, the second patch electrode overlapping the first patch electrode, and the electrode layer overlapping the second patch electrode, and
the first patch electrode, the second patch electrode, and the electrode layer are stacked in a second direction intersecting the first direction and the third direction.

6. The intelligent reflecting surface according to claim 5, wherein
the radio wave is configured to be reflected by the first reflector unit cell and the second reflector unit cell.

7. The intelligent reflecting surface according to claim 1, wherein
the size of the first patch electrode is the same as the size of the second patch electrode.

8. The intelligent reflecting surface according to claim 1, wherein
the first patch electrode and the second patch electrode are arranged so as to be rotationally symmetrical with respect to the center of the first patch electrode and the center of the second patch electrode in a plan view.

9. The intelligent reflecting surface according to claim 1, wherein
the plurality of first patch electrodes is electrically connected to a switching element.

10. The intelligent reflecting surface according to claim 6, wherein
the display panel part includes a plurality of pixels including the transistor and a pixel electrode capable of applying a voltage to the liquid crystal layer,
the plurality of pixels is arranged in a matrix in the first direction and the third direction, and
a plurality of pixel electrodes faces the electrode layer.

11. The intelligent reflecting surface according to claim 10, wherein
the distance between the pixel and a pixel adjacent to the pixel is smaller than the distance between the first reflector unit cell and the second reflector unit cell.

12. The intelligent reflecting surface according to claim 1, wherein
the display panel part further includes a control circuit, and
the control circuit is configured to supply a common voltage or a ground voltage to the electrode layer.
